(19) United States
(12) Patent Application Publication
(10) Pub. No.: US 2013/0238363 A1
(43) Pub. Date: Sep. 12, 2013

(54) MEDICAL EXAMINATION ASSISTANCE SYSTEM AND METHOD OF ASSISTING MEDICAL EXAMINATION

(71) Applicants: Masayuki Ohta, Kodaira (JP); Kumiko Seto, Fuchu (JP)

(72) Inventors: Masayuki Ohta, Kodaira (JP); Kumiko Seto, Fuchu (JP)

(73) Assignee: HITACHI, LTD., Tokyo (JP)

(21) Appl. No.: 13/885,177

(22) PCT Filed: Nov. 18, 2011
(86) PCT No.: PCT/JP2011/006419

§ 371 Date: May 14, 2013

(30) Foreign Application Priority Data
Nov. 26, 2010 (JP) 2010-263075

(51) Int. Cl. G06F 19/00

(52) U.S. Cl. CPC G06F 19/3443
USPC 705/3

(57) ABSTRACT

There is provided a medical examination assistance system that finds similar cases, acquires not only the disease state information of the similar cases but also the information referred to by medical professionals in medical examination of the similar cases, and displays them on the screen. Medical information of a workflow step preceding an ongoing workflow step is acquired using a medical information database in which the information of a workflow and each workflow step is registered so as to be associated with medical information and information referred to in each workflow step, medical information similar to the acquired medical information is extracted from the medical information database, and information referred to in a workflow step subsequent to a workflow step associated with the extracted medical information is acquired and displayed on the screen.

The present application is the U.S. National Phase of International Application No. PCT/JP2011/006419, filed Nov. 18, 2011, which claims the benefit of Japanese Patent Application No. 2010-263075, filed Nov. 26, 2010, the entire contents of which are hereby incorporated by reference.

### TECHNICAL FIELD

The present invention relates to a medical examination assistance system to deal with the examination values or image data of patients and the findings of medical professionals, and relates to a technique suitable to assist determinations in medical interventions of medical professionals.

### BACKGROUND ART

With the spread of medical information systems in recent years, a wide variety of medical information has come to be electronically stored in the hospital. Due to the digitization of medical information, in addition to the effects such as paperless hospitals or an improvement in operational efficiency, the secondary use of stored medical information has been taken into consideration. Specifically, not only the statistical analysis of medical data or support for management improvement but also finding and referring to past cases can be mentioned as an example of the secondary use of medical information. For example, a technique for assisting a diagnosis or treatment plan by finding images of past cases similar to an image to be diagnosed from the PACS (Picture Archiving and Communication System) and referring to the images when a doctor performs diagnostic imaging has been disclosed. In PTL 1, a region of interest is set in an image and similar cases are found and displayed by performing a search in consideration of the time-series changes or the intervals of imaging date and time, thereby assisting the diagnosis.

### CITATION LIST

### Patent Literature

[PTL 1] JP-A-2007-287027

### SUMMARY OF INVENTION

### Technical Problem

A medical intervention sequence performed in the past for a similar case is a medical intervention performed on the basis of determinations of a number of medical professionals involved in the patient. For example, an attending doctor gives an examination order to the department of examination on the basis of a certain determination material, the department of examination performs the examination and reports the result to the attending doctor, and the attending doctor performs a next determination on the basis of the examination result. In addition, occasionally, several doctors or medical professionals hold a conference to determine the course of treatment and the like through discussion. Therefore, when finding and referring to similar cases, what kind of determination a medical intervention sequence performed in the similar cases was based on is very important information. In addition, a medical professional may determine the disease of a patient to be treated while referring to important information which has not been reported from the request side, for example, information of another disease of the same patient, information of the same disease of another patient, or the like rather than determining the disease of a patient with only the information reported from the medical intervention request side. As a specific example, when determining an operation method to be applied to a patient, a medical professional determines the operation method while observing the size of the affected part in many cases, but the threshold value of the size of the affected part that determines the operation method changes with a medical professional in many cases. In such a case, the operation method for the patient to be treated may be determined with reference to the size of the affected part of another patient suffering from the same disease and the operation method determined by a doctor in charge of the patient. In the technique disclosed in PTL 1, however, it is not possible to output the information that was referred to when the determination was made in the medical examination in the similar case. In this case, since the operation method and the size of the affected part of another patient referred to in the similar case are not known, there is a problem in that the basis of the determination in the similar case cannot be known even if the similar case search is used.

### Solution to Problem

In order to solve the above-described problem, a medical examination assistance system according to the present invention has a following configuration. That is, there is provided a medical examination assistance system including: a medical information database in which workflow information to identify a workflow that is a flow of a sequence of medical services of a medical intervention, workflow step information including at least either information to identify a workflow step that is a unit of the medical intervention included in the workflow or information to identify a workflow step preceding or subsequent to the workflow step, medical information that is information relevant to the medical intervention, and reference information that is information to identify information referred to in the workflow step are stored so as to be associated with each other; a similarity calculation unit that calculates a similarity between first medical information, which is associated with a workflow step preceding a first workflow step, and medical information stored in the medical information database; a similar medical information extraction unit that extracts second medical information, which is similar to the first medical information, from the medical information database on the basis of the calculated similarity; a reference information extraction unit that extracts reference information associated with workflow step information of a second workflow step, which is a workflow step subsequent to a workflow step associated with the extracted second medical information, from the medical information database; and a medical information display unit that displays the extracted second medical information and the extracted reference information on a screen.

### Advantageous Effects of Invention

It is possible to assist the operator in making a determination in an ongoing medical intervention while referring to not only the similar cases but also the information referred to when the determination was made in the medical examination in the similar cases.

### BRIEF DESCRIPTION OF DRAWINGS

FIG. 1(A) is a diagram showing an example of the configuration when a medical examination assistance system is installed in a hospital.

FIG. 1(B) is a diagram showing an example of another configuration of the medical examination assistance system.

FIG. 1(C) is a diagram showing an example of another configuration of the medical examination assistance system.

FIG. 1(D) is a diagram showing an example of the configuration of a similar case search unit.

FIG. 2 is a diagram showing an example of the structure of each of a workflow table and a workflow step table included in a medical information database.

FIG. 3(A) is a diagram showing an example of the structure of each of a medical information table and an evidence data table included in a medical information database.

FIG. 3(B) is a diagram showing an example of the structure of each of a processing history table and an input data table included in a medical information database.

FIG. 4 is a diagram showing an example of the structure of a table group included in an examination information database.

FIG. 5 is a diagram showing an example of a flowchart to extract a workflow step from a workflow and assist a medical examination using medical information and a determination statement.

FIG. 6 is a diagram showing an example of a flowchart to assist a medical examination by performing data processing on evidence data.

FIG. 7 (A) is a diagram showing an example of the screen before referring to an examination graph and inputting a determination statement on the basis of a workflow. (B) is a diagram showing an example of the screen when referring to an examination graph. (C) is a diagram showing an example of the screen when inputting a determination statement.

FIG. 8 (A) is a diagram showing an example of the screen before referring to image data and inputting a determination statement on the basis of a workflow. (B) is a diagram showing an example of the screen when referring to image data. (C) is a diagram showing an example of the screen when inputting a determination statement on the basis of a workflow referring to image data.

FIG. 9 is a diagram showing an example of query input when performing similar case search.

FIG. 10 is a diagram showing an example of the concept of similar case search.

FIG. 11 is a diagram showing an example of the similarity calculation flow using evidence data.

FIG. 12 is a diagram showing an example of the similarity calculation flow using text data.

FIG. 13 is a diagram showing an example of a similar case search result.

FIG. 14 is a diagram showing an example of applying a similar case search result to an ongoing workflow step.

FIG. 15 is a diagram showing an example of the similarity calculation flow using a conference flag.

FIG. 16 is a diagram showing an example of the process flow to check the similarity between workflows.

FIG. 17 is a diagram showing an example of the configuration of a data center type medical examination assistance system.

### DESCRIPTION OF EMBODIMENTS

### Overview of the Following Description

The present invention is intended to find a similar case using information stored in a medical information database. In order to explain embodiments for executing the invention, each item of information stored in the medical information database used in the present invention or the database structure will be described first. Next, it will be described how this system stores each information item in the medical information database. Then, similar case search using a medical information database will be described.

### <Explanation Regarding the Definition of the Workflow>

A workflow is the flow of a medical intervention sequence that a medical professional performs for a patient, and workflow information is information regarding the identification of the workflow. A workflow step is a unit of the medical intervention that makes up the workflow, and workflow step information includes information to identify a workflow step and information to identify a workflow step preceding or subsequent to the workflow step.

The relationship between a workflow step and a subsequent workflow step with respect to the workflow step corresponds to the request of the medical intervention. This includes medical intervention ordering with respect to each medical department, for example, a department of examination or a department of diagnostic imaging. Medical professionals include not only a doctor in charge, a laboratory technician, a radiology technician, and a radiologist but also a nurse and those involved in medical accounting. The start and end of the workflow are determined by the attending doctor among clinicians, for example. Examples of the workflow include the flow of a sequence of medical services including diagnosis, treatment, and follow-up for each disease, the flow of medical services during hospitalization (date of admission to date of discharge), and one flow defined by the medical examination guidelines.

Examples of the workflow step include each work in a medical services step (diagnosis, treatment, and follow-up) of a patient, diagnostic services based on the determination made by an attending doctor, work of a nurse such as medical administration, and order of tasks exchanged between medical departments, such as a department of medical examination and a department of radiology. The workflow step information can be edited, for example, newly generated or deleted in each workflow step by the medical professional or the like. In addition, the workflow step information may be based on the medical examination guidelines set in advance. In addition, workflow information has a patient identifier to identify a patient relevant to the corresponding workflow.

### <Explanation Regarding the System Configuration>

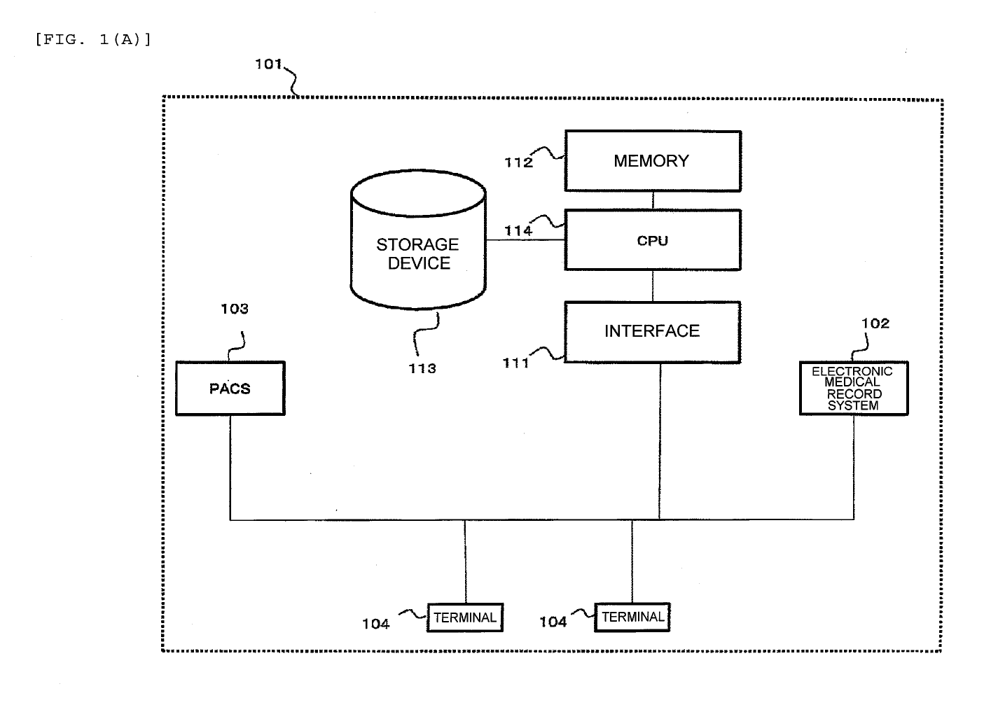

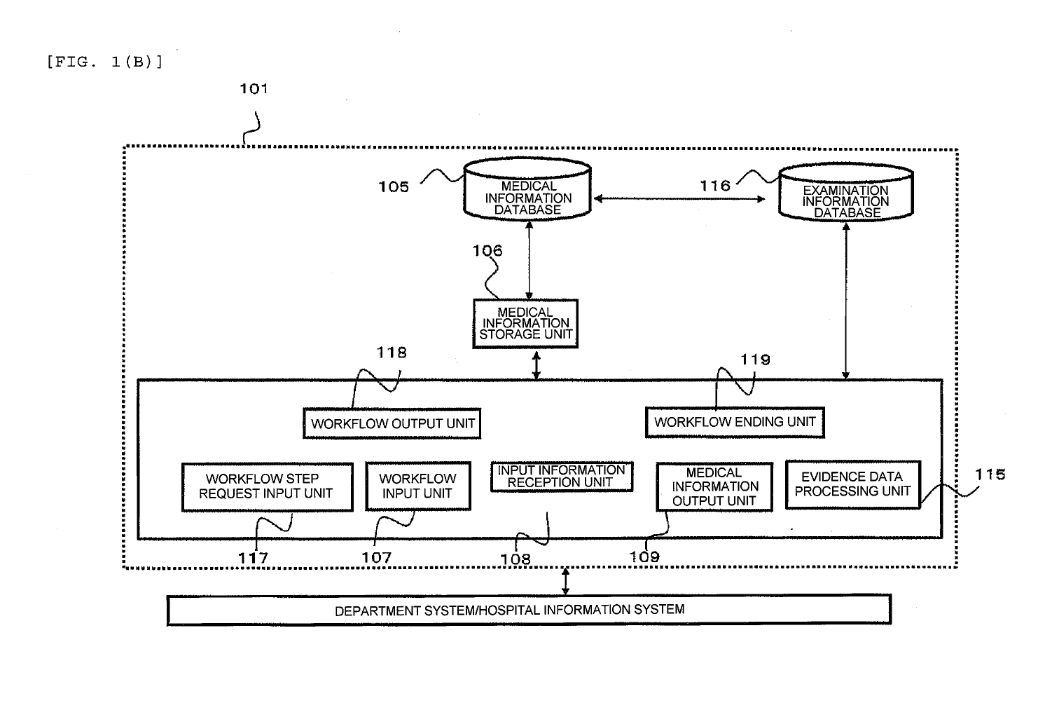

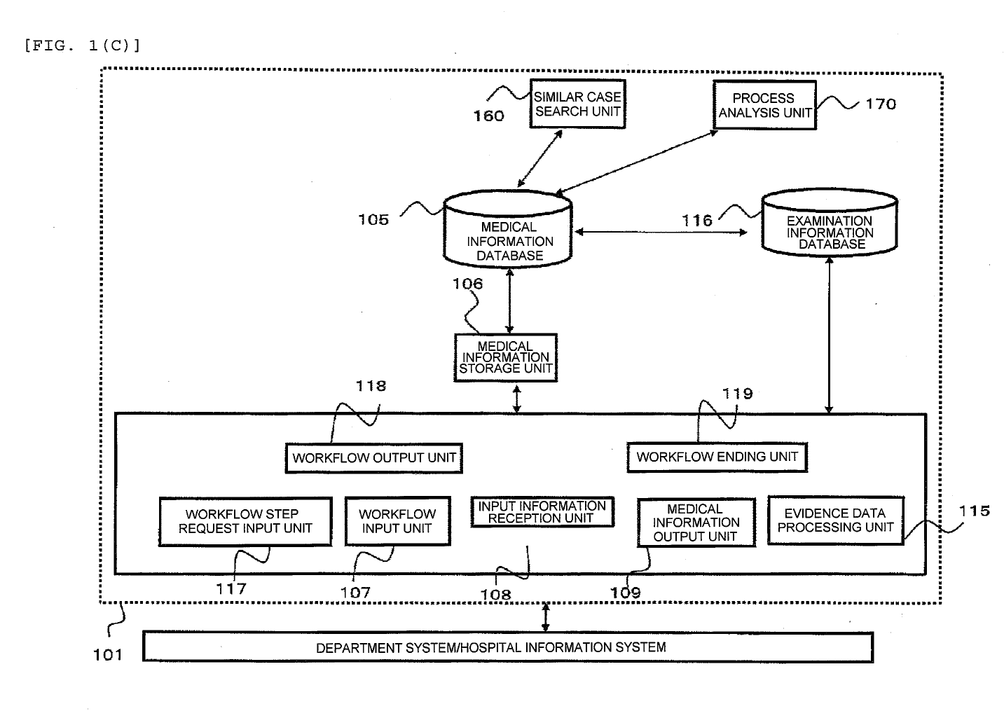

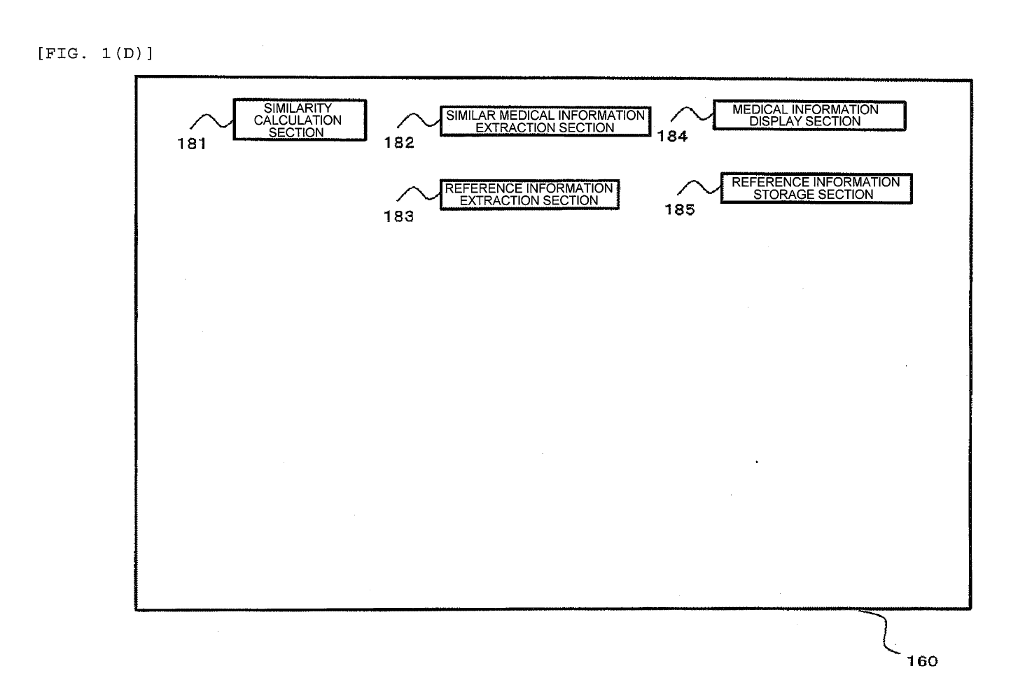

FIG. 1(A) shows an example of the form in which a medical examination assistance system 101 is installed in a hospital. A terminal 104, an interface 111, a memory 112, a storage device 113 such as a hard disk drive, and a CPU 114 are connected to each other. The operation of the medical examination assistance system is performed by receiving an input from the terminal 104 through the interface 111, reading a program stored in the memory 112 to perform information processing using the CPU 114, and outputting the result to the terminal 104 through the interface 111. The medical examination assistance system 101 shown in FIG. 1(A) includes an electronic medical record system 102 and a PACS 103. Although not shown in the drawings, the medical examination assistance system 101 may also be connected to the electronic medical record system 102 and the PACS 103 through a network without including the electronic medical record system 102 or the PACS 103 directly. Each terminal 104 receives an operation input from the medical professional, such as a doctor, a nurse, a laboratory technician, or a radiologist. The electronic medical record system 102 or the PACS 103 may also be used as the terminal 104. Medical examination history, examination values, or image data may be stored in each of the electronic medical record system 102 and the PACS 103. In this case, the storage device 113 of the medical examination assistance system 101 may have information indicating the link to these databases, or may have a copy of the data stored in these databases. In addition, as shown in FIG. 1(B) to be described later, the medical examination assistance system 101 may include an examination information database 116 which is a database of the electronic medical record system 102 or the PACS 103. In addition, an interface including a screen may be mentioned as an example of the interface 111.

FIG. 1(B) shows an example of the configuration of the medical examination assistance system of the present invention. There is a medical information database 105 in which workflow information or workflow step information and medical information, which is information regarding a medical intervention, are stored so as to be associated with each other, and a medical information storage unit 106 that stores these pieces of information is connected to the medical information database 105. The medical information includes information input by the medical professional or evidence data which is objective biological information acquired from the patient. Here, a determination statement, which is a text statement indicating the determination made in the medical intervention, is used as an example of the information input by the medical professional. For example, the evidence data refer to data such as examination values or image data acquired from modality. In addition, the medical examination assistance system 101 includes a workflow step input unit 107 that receives an input to select the workflow step information from the medical information database 105, a workflow step request input unit 117 that receives an input of information regarding the request of a workflow step, an input information reception unit 108 that receives an input of a determination statement, a medical information output unit 109 that extracts medical information from the medical information database 105 on the basis of the workflow step information and outputs the medical information, a workflow output unit 118 that acquires workflow information from the medical information database 105 on the basis of a patient identifier to identify a patient and outputs the workflow information to the interface 111, and a workflow ending unit 119 that stores workflow end information in the medical information database 105. The functions of these units are contained in the memory 112 shown in FIG. 1(A).

Through this configuration, medical information is extracted from the medical information database 105 on the basis of the workflow step information selected by the workflow step input unit 107 and is displayed, and information input by the input information reception unit 108 and displayed medical information are stored in the medical information database 105 so as to be associated with the ongoing workflow step information. In the ongoing workflow step, since medical information referred to is stored together with information input as reference information, information referred to as a basis when performing the workflow step is stored. Accordingly, the process of the medical intervention of the medical professionals can be understood. Here, instead of medical information actually referred to, only information of a link to the medical information may be included in the reference information.

The medical information database 105 stores and manages medical information, which is information regarding the medical intervention in each workflow step, through the medical information storage unit 106. A determination statement input by the input information reception unit 108, evidence data data-processed by an evidence data processing unit 115, a processing history, medical information referred to in each workflow step, and the like are stored so as to be associated with each workflow step. As shown in the FIG. 1(A) described previously, the medical information database 105 may have information of a link to the medical information stored in the electronic medical record system 102 or the PACS 103.

The medical information storage unit 106 is a unit that stores workflow information, workflow step information, and medical information in the medical information database 105. Examples of the stored medical information include evidence data data-processed by the evidence data processing unit 115, data processing history including the processing source data, and information input from the input information reception unit 108 by the medical professional.

The examination information database 116 stores and manages the information of results of medically related examinations, such as blood tests or imaging tests, in each workflow step. This database may be realized by sharing a database of the electronic medical record system 102, a hospital information system such as an ordering system, or an image management system such as the PACS 103, or a data import unit not shown in the drawings may be provided to import data from these systems. In addition, a data input unit not shown in the drawings may be provided so that doctors, nurses, and technicians input the information directly. In addition, patient examination results based on an examination method newly developed by the doctor for the purpose of research may also be input through a data input unit not shown in the drawings, and may be stored and managed together with general examination results. In addition, when the electronic medical record system 102 or the PACS 103 is installed separately from the medical examination assistance system 101, it is possible to have only the information of a link to the examination information stored in the electronic medical record system 102 or the PACS 103. In addition, when a data processing workstation is installed, history of data processing performed by the data processing workstation may be stored in the examination information database 116.

The evidence data processing unit 115 is a unit that performs data processing using the data stored in the examination information database 116. The evidence data processing unit 115 includes a plurality of processing modules. The evidence data processing unit 115 for a doctor who specializes in diagnostic imaging (hereinafter, referred to as a radiologist) includes a basic module for image data input and output processing or various kinds of filtering processing on image data and a functional module called region extraction processing or image alignment processing having an advanced image processing algorithm. The operator performs a series of processing, which is required for medical examination, on data by freely combining the above-described processing modules according to the processing purpose or attributes of the data and performing execution thereof in order.

In addition, although the medical information database 105 and the examination information database 116 are logically divided herein, the medical information database 105 and the examination information database 116 may be physically the same database. For example, the medical information database 105 and the examination information database 116 may be combined as one database. In addition, as shown in FIG. 1(A), the PACS 103 or the electronic medical record system 102 may also be separately used so as to have information of a link to these.

As shown in FIG. 1(C), this system may further include a similar case search unit 160 and a process analysis unit 170. The similar case search unit 160 is a unit that finds a similar case to the case of a designated patient using the data of the patient stored in the medical information database 105 in order to assist the determination of medical professionals. The process analysis unit 170 is a unit that analyzes the process of a medical examination on the basis of data of multiple patients stored in the medical information database 105 and extracts information, which is required for process improvement and optimization, in order to improve the quality and efficiency of the medical examination.

FIG. 1(D) shows each function of the similar case search unit 160 as a block diagram. A similarity calculation section 181, a similar medical information extraction section 182, a reference information extraction section 183, a medical information display section 184, and a reference information storage section 185 are shown. These functions will be described later.

### <Explanation Regarding the Table Structure of a Database>

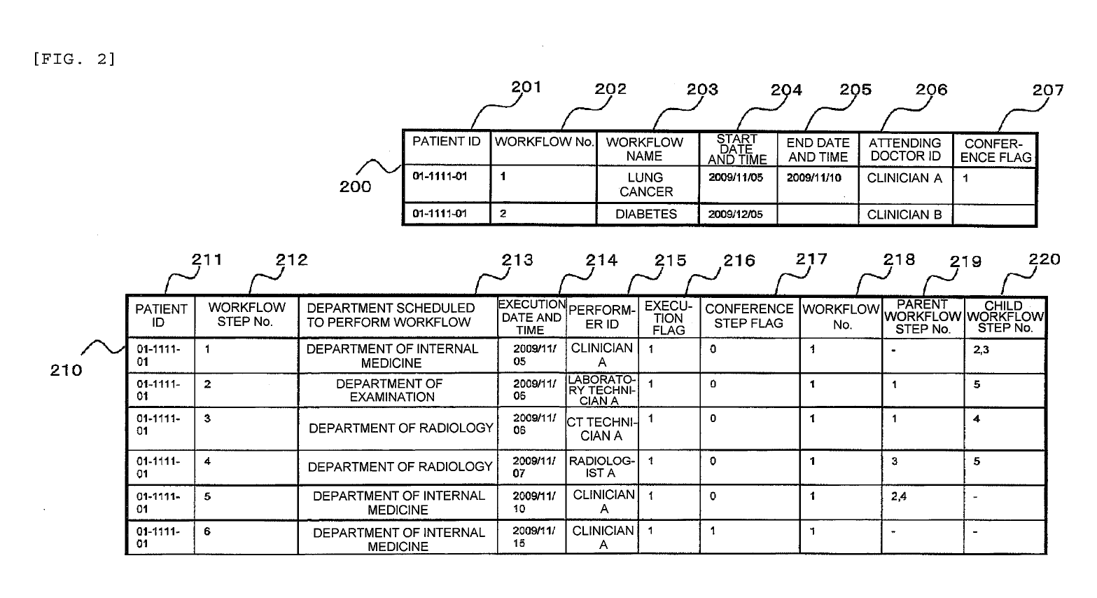

FIG. 2 shows a workflow information table 200 and a workflow step information table 210 included in the configuration of the medical information database 105.

The workflow information table 200 is a table that stores workflow information, which is information to identify the workflow, and is basically registered by the attending doctor. The workflow information table 200 is configured to include a patient ID field 201, a workflow No. field 202, a workflow name field 203, a workflow start date field 204, a workflow end date field 205, an attending doctor ID field 206, and a conference flag field 207. The patient ID field 201 stores a patient identifier which is an identifier to identify a patient. The workflow No. field 202 stores a number or the like used as key information for uniquely designating each item of workflow information. The workflow name field 203 stores a workflow name expressed as the name of a disease, the name of medical treatment, or the like. The workflow start date field 204 stores the start date of the workflow. The workflow end date field 205 stores the end date of the workflow, and is registered when the workflow ends. The attending doctor ID field 206 stores the identification information of the attending doctor who is a person in charge of the workflow. In addition, although a text statement is stored in the workflow name field 203 herein, it is also possible to store the standard master ID of the name of a disease or the name of medical treatment. The conference flag field 207 stores an execution flag indicating that a conference was held in the workflow.

The workflow step information table 210 is a table that stores workflow step information, which is information to identify each step of the workflow, and one step is one record. The workflow step information table 210 is configured to include a patient ID field 211, a workflow step No. field 212, an ID field of a department scheduled to perform a workflow step 213, a workflow step execution date and time field 214, a workflow step performer ID field 215, a workflow step execution flag field 216, a conference step flag field 217, a workflow No. field 218, a parent workflow step No. field 219, and a child workflow step No. field 220. The workflow step No. field 212 stores a number or the like used as key information for uniquely designating each workflow step. The ID field of a department scheduled to perform a workflow step 213 stores identification information for uniquely identifying a department scheduled to perform a workflow step, a department of medical examination scheduled to perform a workflow step, a department of examination scheduled to perform a workflow step, and the like. The workflow step execution date and time field 214 stores a date and time when the workflow step was performed. The workflow step performer ID field 215 stores identification information for uniquely identifying a medical professional who actually performed the workflow step. The workflow step execution flag field 216 stores a flag indicating the execution and non-execution of the workflow step. The conference step flag field 217 is a flag indicating a workflow step for which a conference was held. In addition, the workflow No. field 218 stores identification information for uniquely identifying the workflow to which the workflow step belongs. The parent workflow step No. is identification information for identifying a workflow step, which is further attached to a corresponding workflow step, before the corresponding workflow step. The child workflow step No. is identification information to identify a workflow step, which is further attached to a corresponding workflow step, after the corresponding workflow step. The parent workflow step No. and the child workflow step No. serve to link the order requester and the order receiver to each other.

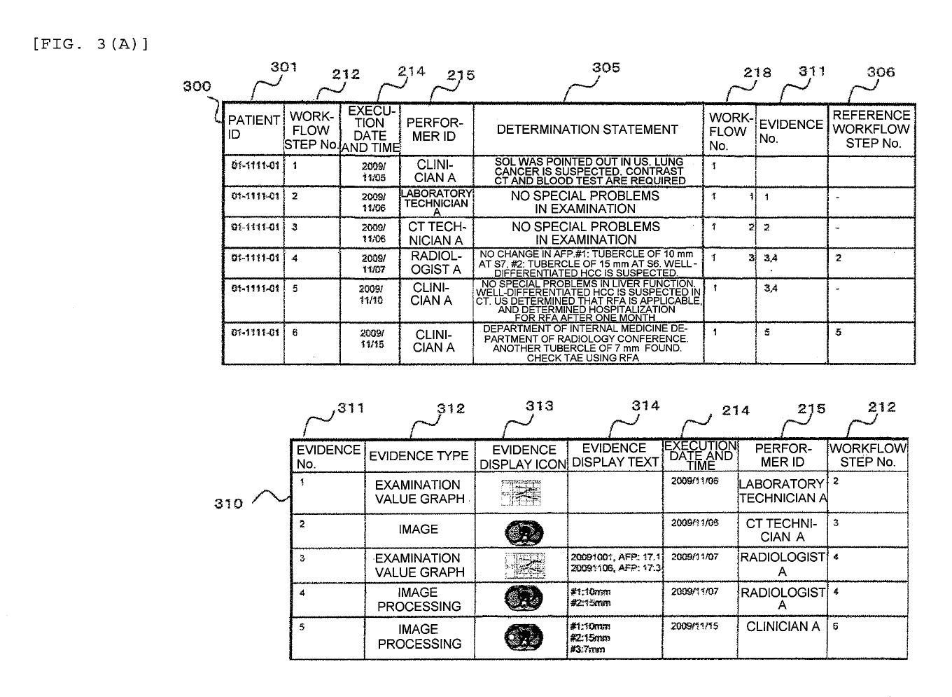

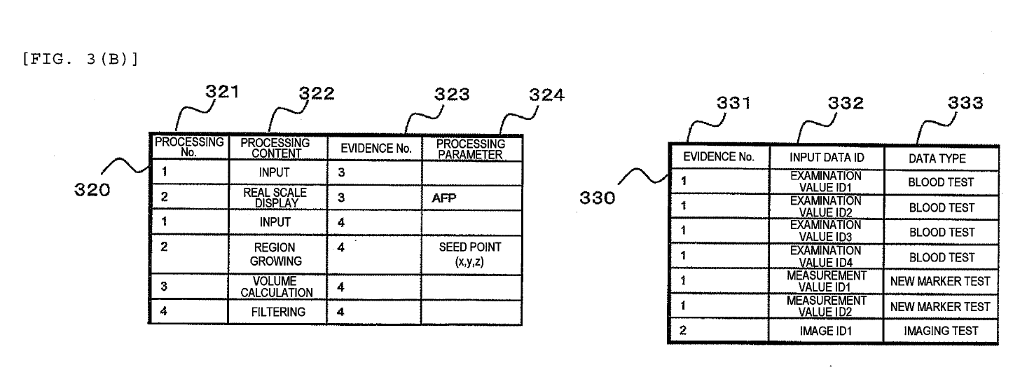

FIG. 3(A) shows a medical information table 300 and an evidence data table 310 included in the configuration of the medical information database 105, and FIG. 3(B) shows a processing history table 320 and an input data table 330 that are similarly stored in the medical information database 105.

The medical information table 300 is a table that stores medical information, which is information regarding the medical intervention, on the basis of a workflow step, and stores one item of medical information in one record. This table is configured to include a patient ID field 301, a workflow step No. field 212, a workflow step execution date and time field 214, a workflow step performer ID field 215, a determination statement field 305, a workflow No. field 218, an evidence No. field 311, and a reference workflow step No. field 306. The patient ID field 301 stores a patient identifier to identify a patient. A determination statement input in the workflow step is stored in the determination statement field 305. In addition, when a determination statement is included in medical information referred to when inputting the determination statement in the determination statement field 305, the reference determination statement can also be stored together with the determination statement. A distinction between the input determination statement and the reference determination statement can be performed on the basis of the reference workflow step No. The workflow step No. field 212 is stored when medical information is registered, and stores the information of a link to the workflow step No. field 212 in the workflow step information table 210. In this manner, the workflow step table information 210 and the medical information table 300 are associated with each other. The evidence No. field 311 is an identifier to designate evidence data generated in the workflow step or evidence data reported from the request side, and is associated with the evidence data table 310. Thus, the determination statement and the evidence data used as a basis of determination are stored in the medical information table 300 on the basis of the workflow step information. The reference workflow step No. field 306 stores the workflow step No. referred to in the workflow step No. of a record.

The evidence data table 310 is a table that stores evidence data, and stores one item of evidence data in one record. The evidence data table 310 is configured to include an evidence No. field 311, an evidence type field 312, an evidence display icon field 313, an evidence display text field 314, a workflow step execution date and time field 214, a workflow step performer ID field 215, and a workflow step No. field 212. The evidence No. field 311 stores a number or the like used as key information for uniquely designating each item of evidence data.

In the evidence data processing unit 115, different processing is performed according to the type of input examination information. For example, image processing is performed on an image, and graphic or statistical processing is performed on the examination value. Here, evidence data for different types of processing, for example, evidence data for image processing and evidence data for graphic processing on the examination value are stored as different records. Therefore, the evidence type field 312 stores the type of medical examination assistance processing from which evidence data is extracted. The evidence display icon field 313 and the evidence display text field 314 store information by which the content of evidence data can be recognized. In addition, although the icon image is directly stored in the evidence display icon field 313 as shown in the drawing, it is also possible to store icon image identification information, such as a file name. The workflow step No. field 212 stores information of a link to the workflow step No. field 212 in the medical information table 300. Due to this link, various kinds of evidence data stored in the evidence data table 310 are matched with the medical information table 300 through the link of the workflow step No.

As shown in FIG. 3(B), the processing history table 320 is a table that stores the history of processing performed on the examination information, which is information before the processing of evidence data, and stores one processing history in one record. History of processing on the examination values or history of processing on the image data is included in the processing history, and these kinds of processing history are also included in the medical information. The processing history table 320 is configured to include a processing No. field 321, a processing content field 322, an evidence No. field 323, and a processing parameter field 324. The processing No. field 321 stores a number or the like used as key information for uniquely identifying each of processes included in the processing history. Minimum information required for the computer to reproduce, analyze, and reuse processing later, that is, information by which the content of processing can be identified is stored in the processing content field 322. Information regarding the processing history of image processing and examination value processing is shown in FIG. 3(B). In the examination value processing (evidence No.=3), a case is shown in which an examination result is read and a plurality of examination items are displayed as a graph in real scale, and “input” and “real scale display” are registered. In the image processing (evidence No.=4), a case is shown in which an examination image is read, region extraction processing (here, for example, a region growing method) is performed for a tumor region, and the volume of the tumor region is calculated, and “input”, “region growing”, and “volume calculation” are registered according to the processing order. The evidence No. field 323 stores the value of the evidence No. field 311 in the evidence data table 310. This indicates that evidence data identified by the same evidence No. was performed in order of the number of the processing No. field 321 or the like. The processing parameter field 324 is a parameter set field when performing each process. In this example, for convenience of explanation, the parameter is placed in one field. However, this changes with processing. Therefore, a different processing parameter table may be prepared for each type of processing. In addition, in this example, each process included in the evidence data is separately stored in a table of the database. However, a processing history binary field may be set in the evidence data table 310 so that processing history and input and output data of each process are also stored in a unique binary format. Then, at the time of reproduction of the process, fast reproduction of the process and easy implementation can be realized by directly transmitting the binary data to the evidence data processing unit 115 without referring to the processing history table 320 or the input data table 330. Thus, the processing history table 320 associates the processing content and the like with records, which are stored in the evidence data table 310 and the medical information table 300, through the evidence No.

The input data table 330 stores input data, which is to be used in the first process of the processing history in evidence data, through a link with the examination information database 116, and stores one item of the input data in one record. The input data table 330 is configured to include an evidence No. field 331, an input data ID field 332, and an input data type field 333. The input data ID field 332 stores a number or the like, which is used as key information for uniquely designating the examination information in the examination information database 116, as input data for the evidence data. The input data type field 333 stores the data type for specifying the link destination of the ID stored in the input data ID field 332. For example, the input data ID is an examination value ID for uniquely identifying the examination value of the patient in the case of “blood test”, an image ID for uniquely identifying an image of the patient in the case of “imaging test”, and a measurement value ID for uniquely identifying the measurement value of the patient in a new marker test in the case of “new marker test”. Thus, the input data table 330 is associated with the records, which are stored in the evidence data table 310 and the medical information table 300, through the evidence No. field 331.

### <Examination Information Database>

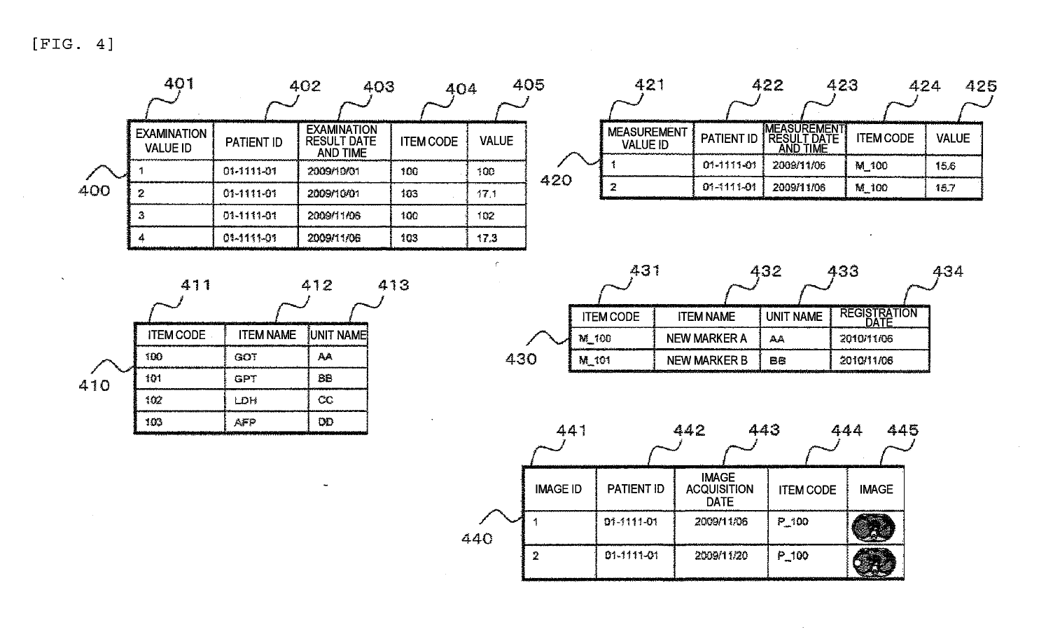

FIG. 4 shows an example of a table group included in the examination information database 116. The examination information database 116 stores detailed information of evidence data regarding a medical examination, and is configured to include an examination value table 400, an examination item master table 410, a measurement value table 420, a measurement item master table 430, and an image table 440. Here, details of each table will be described. The examination value table 400 is a table that stores the content of “blood test” data, and stores one examination value in one record. The examination value table 400 is configured to include an examination value ID field 401, a patient ID field 402, an examination result date and time field 403, an item code field 404, and a value field 405, and is associated with the examination item master table 410 with the item code as a key. The examination item master table 410 is an item master table of “blood test”, and is configured to include an item code field 411, an item name field 412, and a unit name field 413. In addition, the measurement value table 420 is a table that stores the content of the data of “new marker test”, and stores one measurement value in one record. The measurement value table 420 and the measurement item master table 430 are configured to have the same structure as the examination value table 400 and the examination item master 410. The measurement value table includes a measurement value ID field 421, a patient ID field 422, a measurement result date and time field 423, an item code field 424, and a value field 425. The measurement item master table 430 includes an item code field 431, an item name field 432, and a unit name field 433. In addition, in the measurement item master table 430, a field for storing the registration information (for example, a registration date field 434 or the like) of the measurement item may be set in addition to the fields included in the examination item master 410 so that item versions can be managed.

As described above, a configuration is adopted herein in which the content of input data is managed separately for “blood test” and “new marker test” in the examination information database 116 and only the link information is uniformly managed by the input data table 330. In this case, since both the examination values measured by routine work and the examination values based on an examination method newly developed for the purpose of research can be similarly stored as evidence data, it is possible to analyze the effectiveness of the newly developed examination method.

The image table 440 is configured to include an image ID field 441 that stores an identifier to identify an image, a patient ID field 442 that stores a patient identifier, an image acquisition date field 443 that stores date and time of the acquisition of an image, an item code field 444 that stores an item code, and an image field 445 that stores an image.

### <Explanation Regarding the Data Storage Operation>

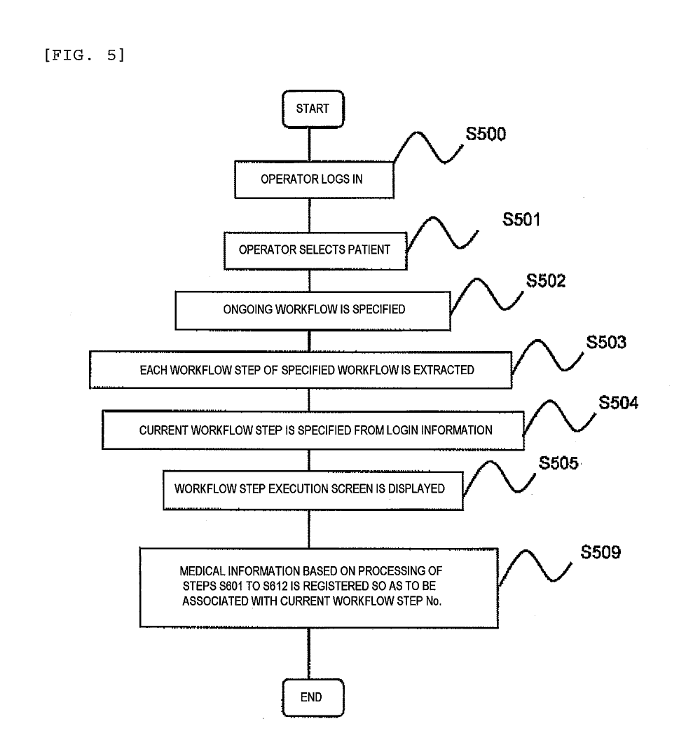

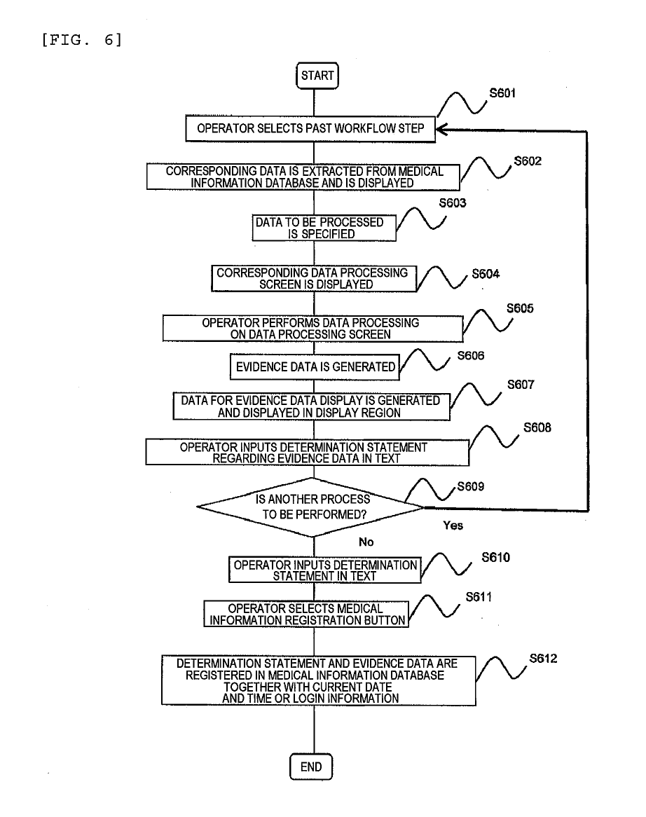

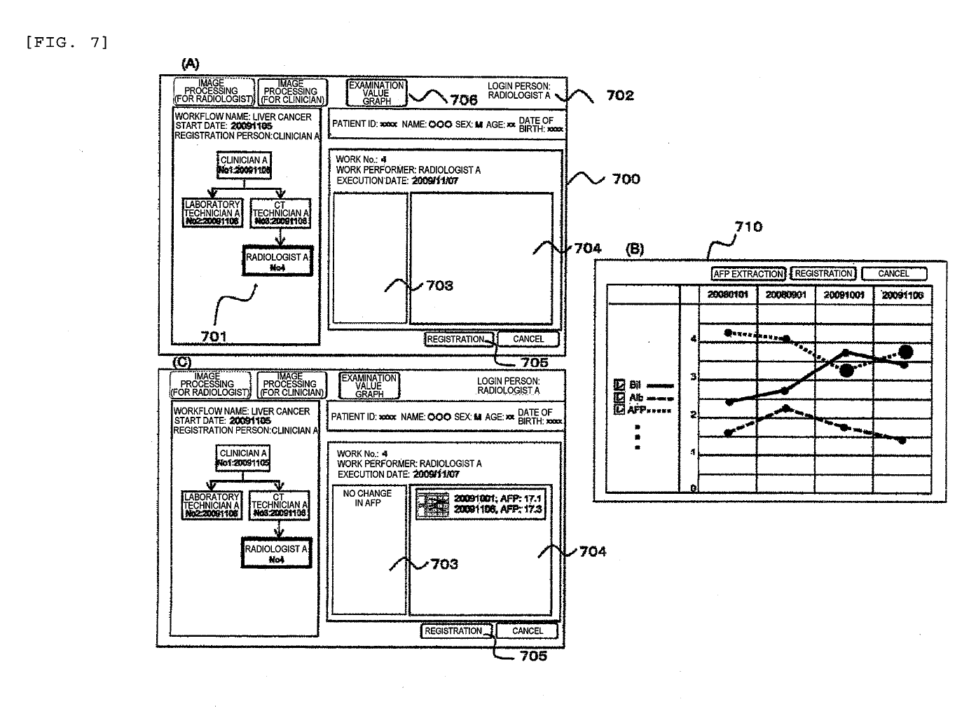

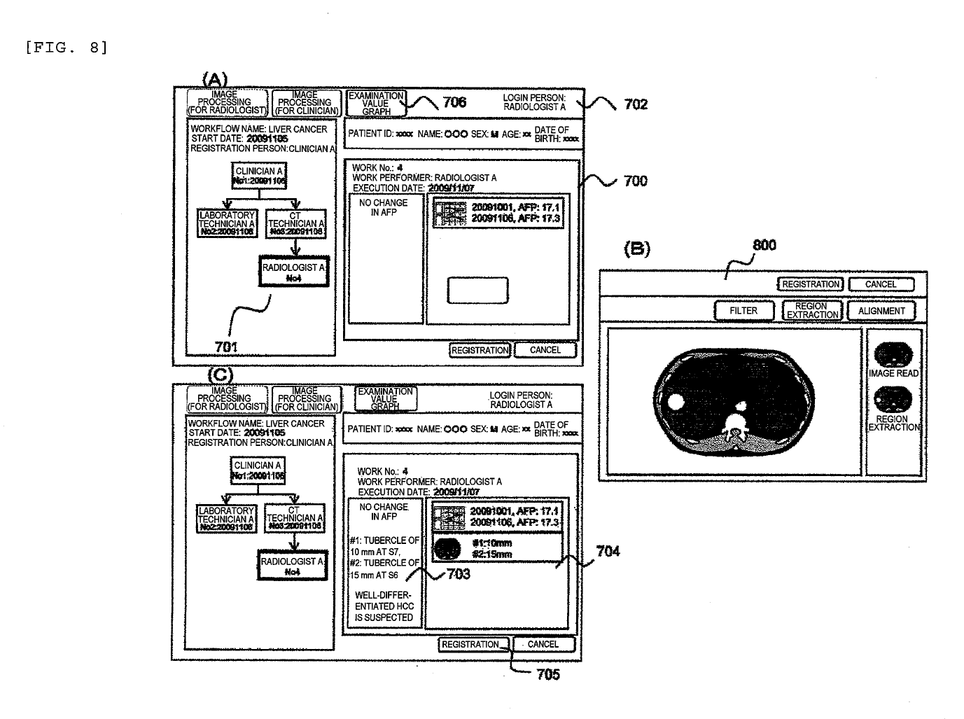

Next, an operation when storing the data used for similar case search by this system will be described in detail using the process flows shown in FIGS. 5 and 6 and screen examples shown in FIGS. 7 and 8.

In this system, the terminal 104 receives a login input from the operator through the login screen first (step S500). Then, when the terminal 104 receives an operator's input to select a patient identifier of a patient through the patient selection screen (step S501), the medical information storage unit 106 identifies the ongoing workflow No. from the workflow information table 200 shown in FIG. 2 using the record corresponding to the patient that has been acquired in step S501 (step S502). Here, as examples of the method of identifying the ongoing workflow No, a record in which the value of the workflow end date and time field 205 is not registered may be identified, or a method may be adopted in which all records corresponding to the patient acquired in step S501 are extracted from the workflow information table 200, a workflow selection screen is displayed, and the operator designates one workflow.

The medical information storage unit 106 acquires the corresponding workflow step information from the workflow step information table 210 shown in FIG. 2 on the basis of the workflow No. identified in step S502 (step S503). The current workflow step No. is identified from the department information of the login information acquired in step S500 (step S504). The current workflow step indicates an ongoing workflow step in the workflow. As an example of the identification of current workflow step, the medical information storage unit 106 identifies a current workflow step by extracting the workflow step No., which has not been performed in steps of the login person's department and the corresponding department, as the current workflow step No. with reference to the ID field of a department scheduled to perform a workflow step 213 and the workflow step execution flag field 216 in the record acquired in step S502. In addition, when all steps have been performed, the final step No. is set as the current workflow step No. Then, the workflow output unit 118 sets and displays the workflow step information acquired in step S503 on a workflow step execution screen 700 shown in FIG. 7 (step S505). This workflow step execution screen 700 is displayed on the interface 111 shown in FIG. 1.

For example, as shown in the drawing, a login information display area 702, a workflow step selection area 701, a determination statement input and output area 703, an evidence data display area 704, a medical information registration button 705, and a medical examination assistance button group 706 are included in the workflow step execution screen 700 in FIG. 7. The workflow step selection area 701 displays workflow steps from the start step of the workflow to the current step in a flow format on the basis of the information of the parent workflow step No. field 219 in the workflow step information table 210. For example, as shown in the workflow step information table 210 in FIG. 2, parent workflow step Nos. of workflow steps whose workflow step Nos. are 2 and 3 are 1. Accordingly, the workflow steps whose workflow step Nos. are 2 and 3 are displayed so as to be connected to the workflow step whose workflow step No. is 1. In addition, the parent workflow step No. of a workflow step whose workflow step No. is 4 is 3. Accordingly, the workflow step whose workflow step No. is 4 is connected to the workflow step whose workflow step No. is 3. The steps can be similarly connected even if the child workflow step No. is used. Thus, the workflow information and the workflow step information are displayed in the workflow step selection area 701 shown in FIG. 7 such that the requester and the request receiver are connected.

The login information display area 702 is an area to display the information of an operator who is currently logged in to the system. The determination statement input and output area 703 is an area to display the determination content of medical professionals that is input and output in a text format. The evidence data display area 704 displays evidence data. The medical information registration button 705 is a button that is clicked by the operator in order to combine the evidence data and the text statement and register the result in the medical information database 105. The medical examination assistance button group 706 is a button used when a medical professional invokes the function of the evidence data processing unit 115, which performs data processing such as image processing or examination value processing, for medical examination of the patient. The medical examination assistance button group 706 may be set to be selectable or not to be selectable from the job information of the login information acquired in step S500.

In addition, here, for example, the current workflow step identified in step S504 is highlighted in the workflow step selection area 701. In addition, information from which the progress of the workflow can be seen is displayed in each workflow step. In FIG. 7, a display format is adopted in which completion and incompletion can be distinguished by changing a display color according to the content of the workflow step execution flag field 216, for example. In addition, for the completed workflow step, the content of the workflow step execution date and time field 214 or the workflow step performer ID field 215 is displayed.

Here, it is assumed that a radiologist A proceeds to the interpretation work and registers medical information. The radiologist A performs the interpretation work through the process (will be described later) of steps S601 to S612 in FIG. 6. After the interpretation work ends, the medical information storage unit 106 registers the medical information, which is displayed so as to match the current workflow step No. identified in step S504, in the medical information database 105 (step S509).

FIG. 6 shows a detailed operation of the system when registering the medical information. Here, an example based on this system is shown in which, in the workflow step of interpretation work, interpretation is performed with medical information reported from a CT technician A on the request side while referring to the medical information in the workflow step of the laboratory technician A and the reported medical information, the reference medical information, and the interpretation result are stored so as to be associated with the ongoing workflow step.

The operator performs an input to select the workflow step information of the laboratory technician A (step S601). The workflow step input unit 107 receives an input to select the workflow step information from the medical information database 105. The medical information output unit 109 searches for medical information, which is relevant to the selected workflow step (workflow step No. 2) of the laboratory technician A, from the medical information database 105, and displays the medical information on the workflow step execution screen 700 (step S602). Here, it is assumed that the examination value graph of the evidence No. 1 acquired by the laboratory technician A is registered in the medical information. The radiologist A specifies the displayed examination value graph as data to be data-processed (step S603). An examination value graph screen 710 shown in FIG. 7(B) is displayed (step S604). On the examination value graph screen 710, the input of data processing, such as the selection of an examination item to be displayed, setting of a graph format, and extraction of a point of interest or data variation, is received (step S605). Here, it is assumed that that data processing for selecting and extracting the value of AFP, which is called “AFP extraction”, is performed. By the “AFP extraction”, the evidence data processing unit 115 extracts the value of AFP selected by the operator from the data of AFP on the examination value graph. FIG. 7(B) shows the data of selected AFP by enlarging dots showing the data of two selected points. The value and date of the AFP extracted in step S605 are acquired as evidence data together with the displayed examination value graph (step S606). The medical information output unit 109 generates data for evidence data display “graph icon file 1” and “20091001, AFP: 17.1, 20091106, AFP: 17.3” from the acquired evidence data, and displays the data in a first row of the evidence data display area 704 (step S607). Then, the operator inputs the determination statement “No change in AFP”, which is relevant to the data processing of the examination value graph, into the determination statement input and output area 703 (step S608). The input information reception unit 108 receives this input.

The operator determines whether to perform another data process (step S609). When another data process is to be performed, the process returns to step S601 to repeat the processing. In this example, it is assumed that the operator performs image processing on a CT image captured in the next workflow step of the CT technician A. In response to the report from the workflow step (workflow step No. 3) of the CT technician A, image data (evidence No. 2) is acquired and displayed in step S602. The displayed image data is specified as data to be processed (step S603). In step S604, an image processing screen 800 shown in FIG. 8(B) is displayed. In step S605, the radiologist A extracts a tumor region from the CT image. In addition, details of the processing on the image processing screen 800 will be described later. In step S606, image processing history and input data “image ID1” until the volume of the tumor region is calculated after image input and region extraction from the image processing screen 800 are acquired. In step S607, data for evidence data display “image icon file 1” and “#1: 10 mm #2: 15 mm” is generated using the information of the image processing history, and is displayed in the evidence data display area 704. In step S608, the operator inputs the determination statement “#1: tubercle of 10 mm at S7, #2: tubercle of 15 mm at S6” relevant to image processing into the determination statement input and output area 703. The input information reception unit 108 receives this input.

Then, when it is determined that the operator does not perform additional processing in step S609, a determination statement which is not based on the evidence data, for example, “well-differentiated HCC is suspected” is additionally input into the determination statement input and output area 703 as necessary (step S610). The input information reception unit 108 receives this input. Finally, the operator selects the medical information registration button 705 (step S611). When the medical information registration button 705 is selected, the medical information storage unit 106 acquires current date and time, for example, from the hardware, in which the medical examination assistance system is mounted, and also acquires the medical professional information “radiologist A” of a login person from the medical information database 105. The medical information storage unit 106 registers the text statement of the determination statement input and output area 703, the input data and the processing history extracted by the evidence data processing unit 115, and the patient identifier, date and time, medical professional information, workflow step execution flag “true”, and workflow step No., which have been selected in step S501, in each table of the above-described medical information database 105 (step S612). In this example, evidence No. 3 is registered corresponding to the data-processed examination value graph, and evidence No. 4 is registered corresponding to the image-processed data.

In addition, in this example, text statements input and output in steps S608 and S610 are treated as one data item in the determination statement input and output area 703. However, the determination statement input and output area 703 may be divided into the input and output area of the determination statement (determination statement area of the examination value graph, determination statement area of image processing) for each item of evidence data and the input and output area of the determination statement relevant to all pieces of evidence data, and each of the determination statements may be separately registered by adding tag information for distinguishing them from each other in step S612. In addition, for the determination statement of each item of evidence data, it is possible to set the information of a link to the evidence data.

Thus, it is possible to store the process of the medical intervention of medical professionals, such as how the medical professionals made such determination based on which data in each workflow step, so as to match each workflow step by displaying the evidence data corresponding to the medical intervention in a workflow step performed before the current workflow step, and performing data processing, and receiving the input of a determination statement based on the data-processed evidence data in the current workflow step, and registering the determination statement and the evidence data displayed at the time of input of the determination statement so as to match the current workflow step. In this manner, it is possible to assist a medical examination while using the implicit knowledge of each medical professional according to the workflow. In addition, the correspondence relationship between the data processing history and the determination of the medical professional in each workflow step can also be stored by storing the evidence data processing history on the basis of the workflow step.

### <Operation Example of Similar Case Search>

An operation example at the time of similar case search using the medical information stored as described above will be described below. A situation used as an example herein is a situation where a clinician A who treats a liver cancer patient tries to check the determination of the medical professional, who was in charge of a case similar to the case appearing in the workflow step that the clinician A is responsible for, and its basis using similar case search.

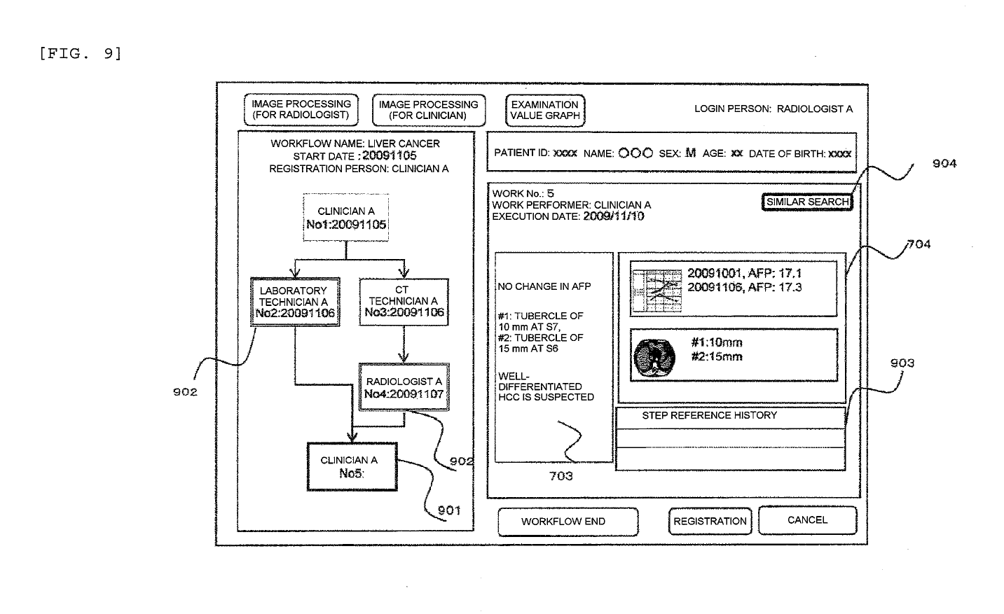

FIG. 9 shows a screen in the ongoing workflow step of the clinician A. A display method of ongoing workflow step information 901 may be changed so as to be understandable by the user. For example, the ongoing workflow step information 901 may be highlighted in bold. In this example, as workflow steps preceding the ongoing workflow step of the clinician A, workflow steps of the radiologist A and the laboratory technician A and the like are positioned, and medical information associated with these workflow steps are displayed. Evidence data is displayed in the evidence data display area 704, and a determination statement is displayed in the determination statement input and output area 703. In addition, when another workflow step is referred to in the workflow step, a workflow step reference history area 903 showing the reference history is displayed on the screen. In the example shown in FIG. 9, this workflow step reference history area 903 is still blank.

When the clinician A makes a diagnosis with reports of medical information associated with the workflow steps of the radiologist A and the laboratory technician A, the clinician A presses a similar case search button 904 in order to refer to the determination of the medical professional, who received reports of medical information similar to the medical information, and its basis. This system operates in response to this pressing.

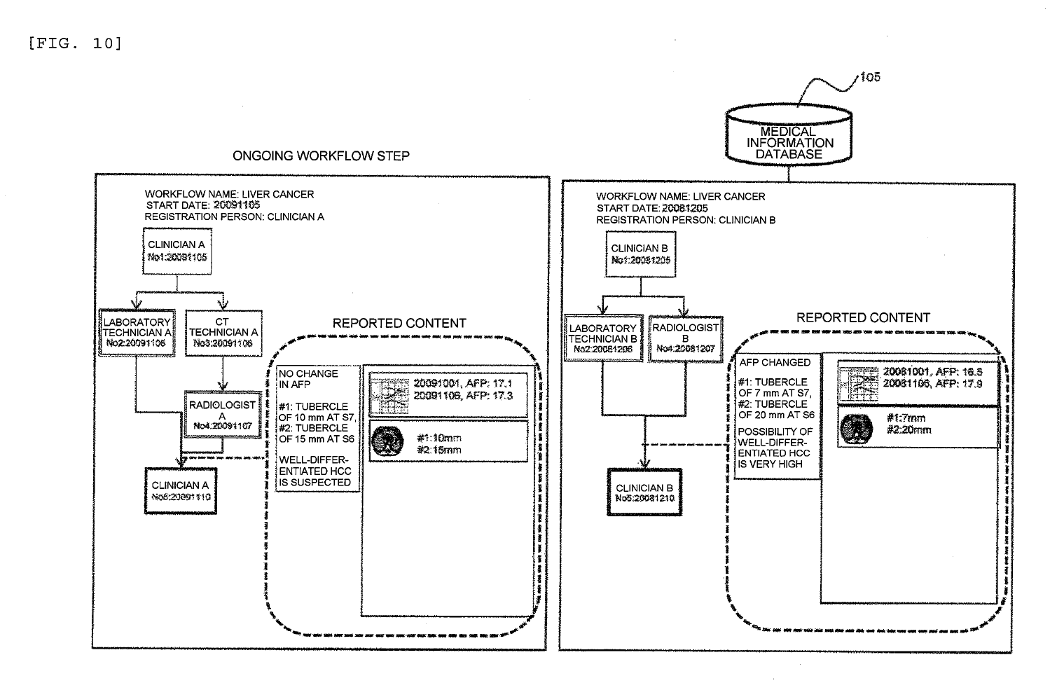

FIG. 10 is a schematic diagram of a search image. FIG. 10 shows that a workflow step for which medical information similar to the medical information in the report, which has been received for the ongoing workflow step, is extracted from the medical information database 105 by calculating the similarity between the pieces of medical information.

### <Regarding the Calculation of the Similarity of Evidence Data>

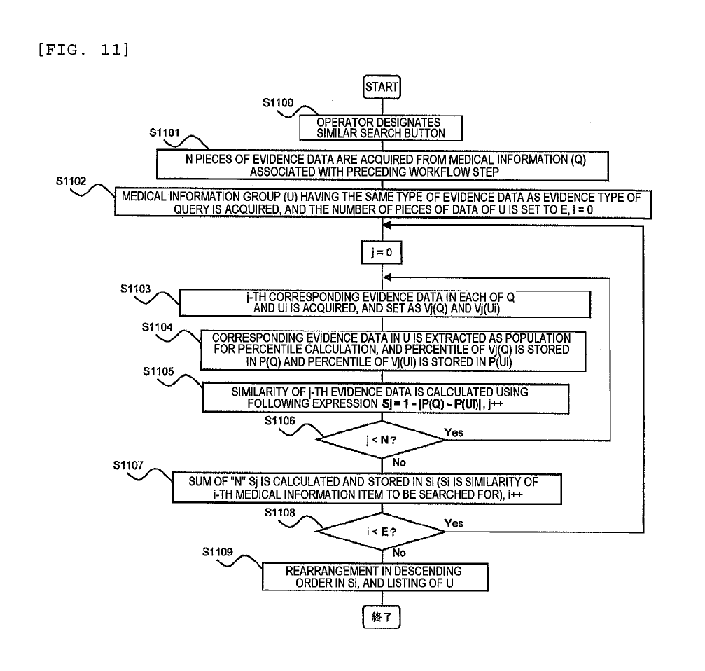

FIG. 11 shows a flowchart when the similarity calculation section 181 calculates the similarity of evidence data. First, when the similar case search button 904 is selected by the operator (step S1100), the similarity calculation section 181 extracts N pieces of evidence data of medical information (hereinafter, referred to as Q), which is associated with a workflow step preceding the ongoing workflow step, from the medical information database 105 (step S1101). These N pieces of evidence data are queries to find similar cases. In this example, since the number of pieces of evidence data is 2, N=2. The content of these pieces of evidence data is “20091001, AFP: 17.1, 20091106, AFP: 17.3”, which is evidence data regarding examination values, and “#1: 10 mm #2: 15 mm”, which is evidence data regarding the tumor size of the CT image.

Then, the similarity calculation section 181 acquires a medical information group (U) of past cases, which have evidence data of the same evidence type as the query Q, from the medical information database 105 (step S1102). The same evidence type indicates that data in the evidence type field 312 in the medical information database 105 is the same, as will be described later. For example, this is an “examination value graph” or an “image”. In addition, the number of data items of U is set to E herein for convenience of explanation.

First, in order to extract one piece of medical information Ui from the medical information group U, for which the similarity is to be calculated, and calculate the similarity between Q and Ui, the similarity calculation section 181 acquires corresponding evidence data from each piece of the medical information and sets the acquired evidence data as Vj(Q) and Vj(Ui) (step S1103). Here, the correspondence relationship between the pieces of evidence data will be described. As shown in FIG. 3(A), the evidence type 312 or the performer ID 215 is associated with evidence data. The type of evidence data is specified using these pieces of information, and the same type of evidence data is extracted as corresponding evidence data. The evidence type 312 associated with each piece of the evidence data is extracted, and evidence data associated with the same evidence type as this extracted evidence type 312 is acquired. For example, when the evidence type of the evidence data of the medical information Q is an examination value, evidence data whose evidence data type is an examination value is acquired from the medical information database 105. Similarly, corresponding evidence data may be acquired using the performer ID 215.

Then, all pieces of corresponding evidence data are extracted from U, and Vj(Q) and Vj(Ui) are normalized (step S1104). In this example, the normalization is performed using the percentile. However, it is also possible to adopt other common normalization methods, such as assuming a normal distribution. Here, the percentile refers to the ranking in the whole set when arranging the quantitative information in ascending order. For example, the meaning of the 10th percentile is the 10th from the lower of 100 pieces of numerical information. When calculating the percentile of evidence data, one set including the feature amount of each piece of the evidence data, which has the same evidence type as the evidence data of Vj(Q), is extracted from the medical information database 105, and the percentile is calculated as a ranking when arranging the feature amounts in ascending order in this set. Assuming that the percentile of Vj(Q) in this set is P(Q) and the percentile of Vj(Ui) is P(Ui), the similarity Sj regarding this evidence output is calculated as Sj=1−|P(Q)−P(Ui)| (expression 1) (step S1105).

The similarity calculation section 181 calculates “N” Sj by repeating the steps S1103 to S1105 by the number of pieces of the evidence output data of Q (step S1106), and calculates the similarity between Q and Ui by calculating the sum (step S1107). In addition, by determining whether to perform the above-described similarity calculation for all pieces of medical information included in U (step S1108), it is possible to calculate the similarity between Q and all pieces of the medical information included in U.

### <Regarding Determination Statement Similarity Calculation>

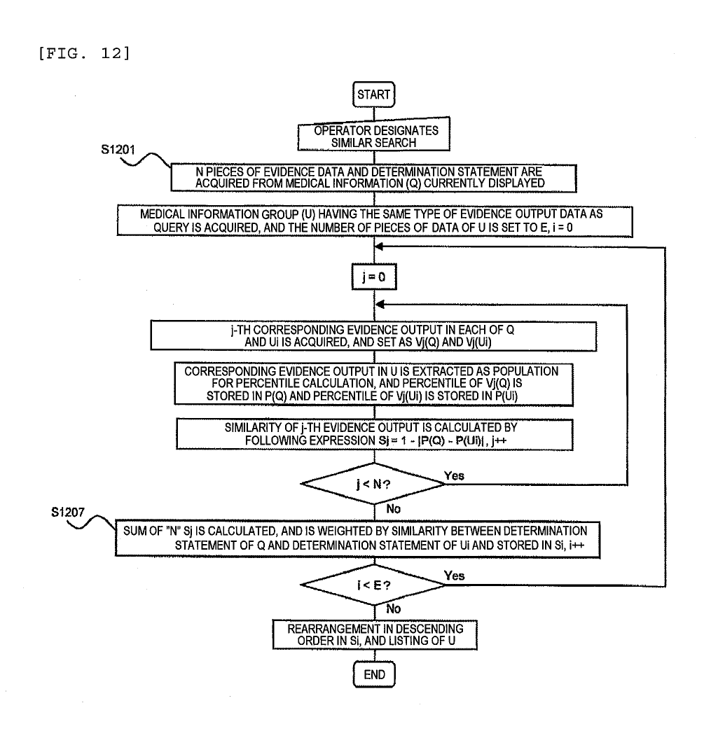

Since determination statements are included in medical information when calculating the similarity of the medical information, the operation of this system when calculating the similarity in consideration of the similarity between these determination statements will be described in detail using the process flow shown in FIG. 12. Reference numerals of the same steps as in FIG. 11 are omitted.

In step S1201, a determination statement included in the medical information used as a query is acquired. When calculating the similarity using the process flow in this example, the determination statement of the medical information used as a query is essential. However, the determination statement does not necessarily need to be a determination statement completed as a sentence having a subject and a predicate. For example, the similarity calculation of the present embodiment is possible even if only the key word is input.

In addition, in step S1207, the similarity calculation section 181 calculates the similarity Wt between the determination statement of Q and the determination statement of Ui apart from the sum of the similarity Sj calculated using the evidence output data. Sj is weighted by the multiplication of Sj and Wt, and the result is stored in Si. As the Sj weighting method, not only the multiplication but also the combination of the four fundamental arithmetic operations may be used. The similarity Wt between the determination statements may be calculated using the word frequency, that is, the degree of co-occurrence, or may be calculated by scoring each word on the basis of the presence or absence of each word. In addition, as pre-processing for calculating the similarity Wt, it is preferable to apply a dictionary for extracting a medically meaningful word on the basis of the information of an external medical encyclopedia or the like, and it is also possible to set the importance of the similarity Wt separately so that Wt is further weighted.

### <Regarding the Output of a Similar Case>

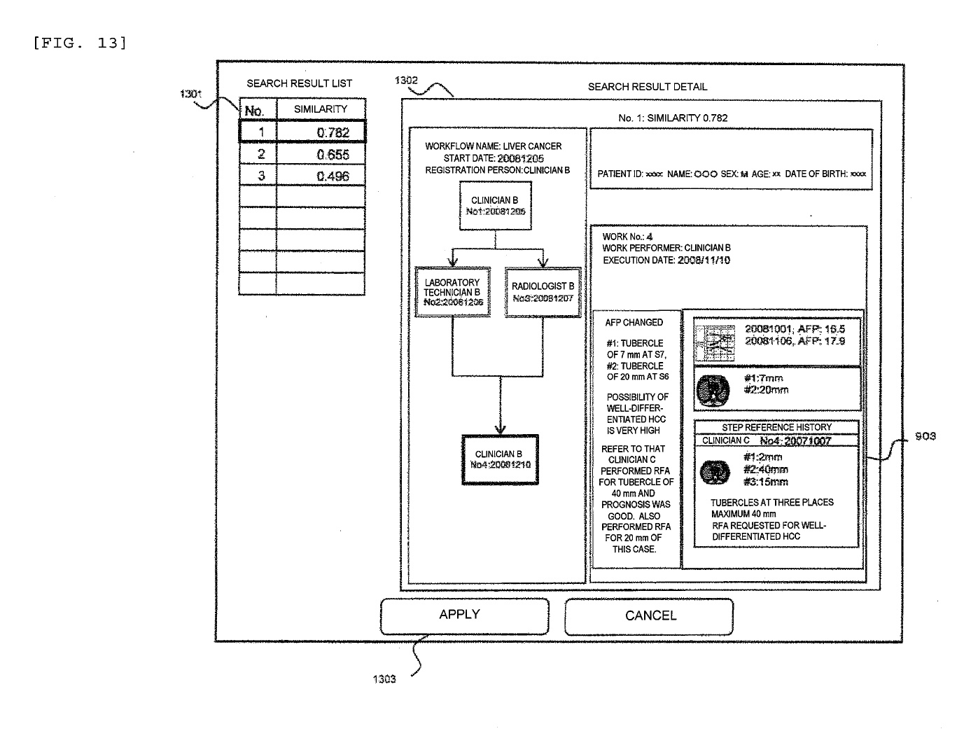

FIG. 13 shows an example of the similarity calculation result. The similar medical information extraction section 182 extracts medical information shown by U, which is rearranged in descending order of similarity, from the medical information database 105 according to the similarity calculated by the method described above, and displays the medical information on the screen. On a search result list screen 1301, the calculated similarity and the workflow step information reported from the extracted medical information are listed. In addition, by displaying the details of the workflow step information selected from the search result list screen 1301 on a search result detail screen 1302 so as to be referred to, it is possible to assist the operator in inputting the determination statement while referring to the medical information in the workflow step indicating the similar case.

The reference information extraction section 183 extracts workflow step information referred to in the similar workflow step from the medical information database 105 on the basis of the reference workflow step No. associated with the similar workflow step information selected on the search result list screen 1301, and displays the workflow step information in the workflow step reference history area 903. Then, the medical information display section 184 extracts medical information associated with the displayed workflow step from the medical information database 105, and displays the medical information. Similarly, medical information associated with the similar workflow step information is also extracted from the medical information database 105 and is displayed.

Through the information processing described above, it is possible to assist the operator in making a determination in an ongoing medical intervention while referring to not only the similar cases but also the information referred to when the determination was made in the medical examination in the similar cases.

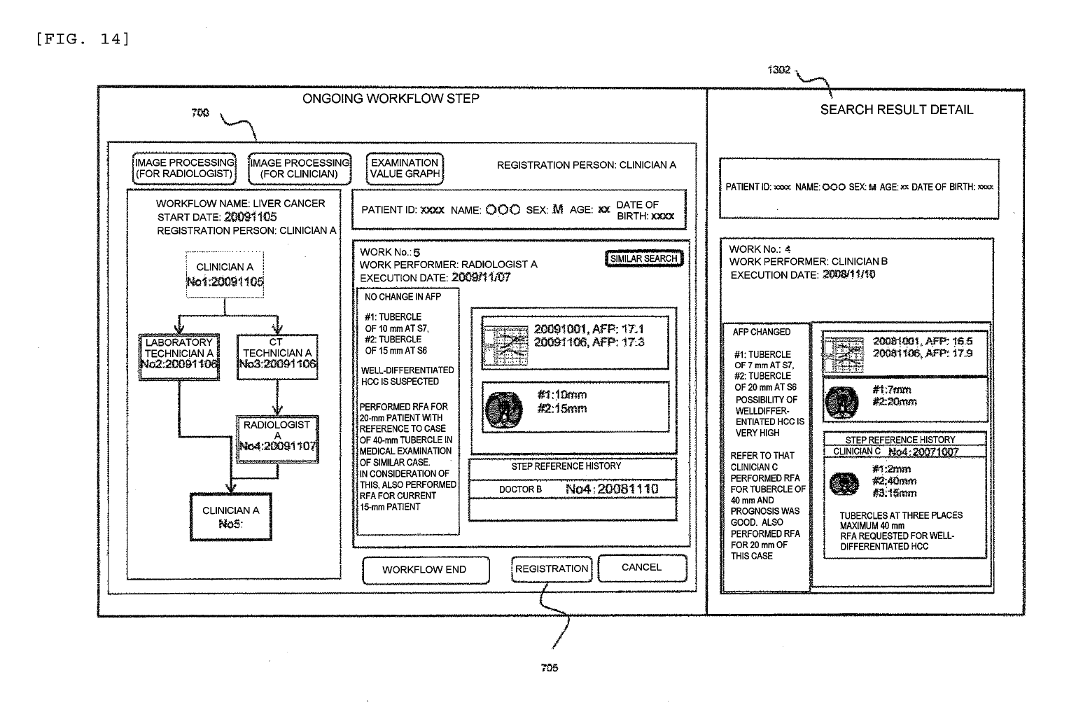

FIG. 14 shows an example of the output screen when an apply button 1303 is pressed in FIG. 13. The ongoing workflow step execution screen 700 and the search result detail screen 1302 are simultaneously displayed in one interface 111. The workflow step information referred to in the applied similar workflow step is displayed as reference history in the workflow step reference history area 903. When the registration button 705 is pressed, the reference information storage section 185 associates the reference history, which is displayed in the workflow step reference history area 903, with the ongoing workflow step and stores the result in the medical information database 105 as reference information.

Thus, by registering the history indicating that the information referred to when making a determination during the medical examination in the similar case has also been referred to at the time of determination in the ongoing workflow step, it is possible to visualize the basis of determination hierarchically to assist the utilization of implicit knowledge in the medical examination of medical professionals.

Although the workflow step information referred to is extracted on the basis of reference information herein, information identified by the reference information may not be workflow step information. For example, it may be an external medical encyclopedia, standard medical examination guidelines, and the like.

### <Similar Case Search Using Conference Flag Information>

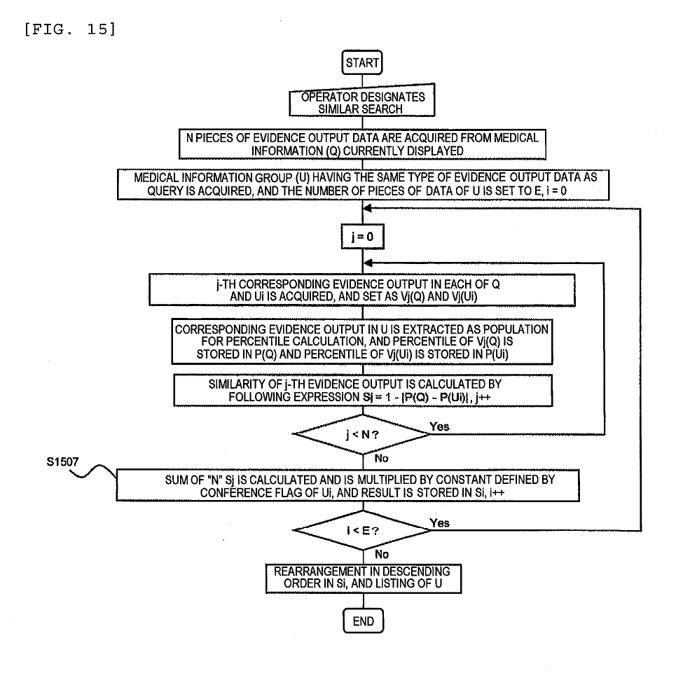

The operation of this system when calculating the similarity using a conference flag recorded in the conference flag field 217 stored in the medical information database 105 will be described in detail using the process flow shown in FIG. 15. Reference numerals of the same steps as in FIG. 11 are omitted.

In step S1507, the similarity calculation section 181 acquires the conference flag of the workflow step associated with the medical information Ui, for which the similarity is to be calculated, from a workflow step table 1010 apart from the sum of the similarity Sj calculated using the evidence output data. The conference in the medical field is usually a meeting held by medical professionals including multiple doctors, and the medical information generated in the conference means medical information approved by multiple medical professionals. Accordingly, it can be said that the medical information whose conference flag is “true” is more reliable medical information. Then, in order to weight the similarity Sj using a conference flag, it is possible to set one or more constants Cf in advance and to weight the similarity by multiplying Sj by Cf when the conference flag is “true”. Alternatively, an input screen for the operator to set Cf may be separately provided.

As described above, according to the present embodiment, more reliable medical information is presented at the top of the search results by performing weighting using a conference flag when calculating the similarity in medical information search. As a result, the effect of improving the search accuracy can be expected.

### <Regarding the Calculation of the Similarity Between Workflows>

Next, the operation of this system when calculating the similarity between workflows by associating the above-described medical information with a workflow will be described in detail.

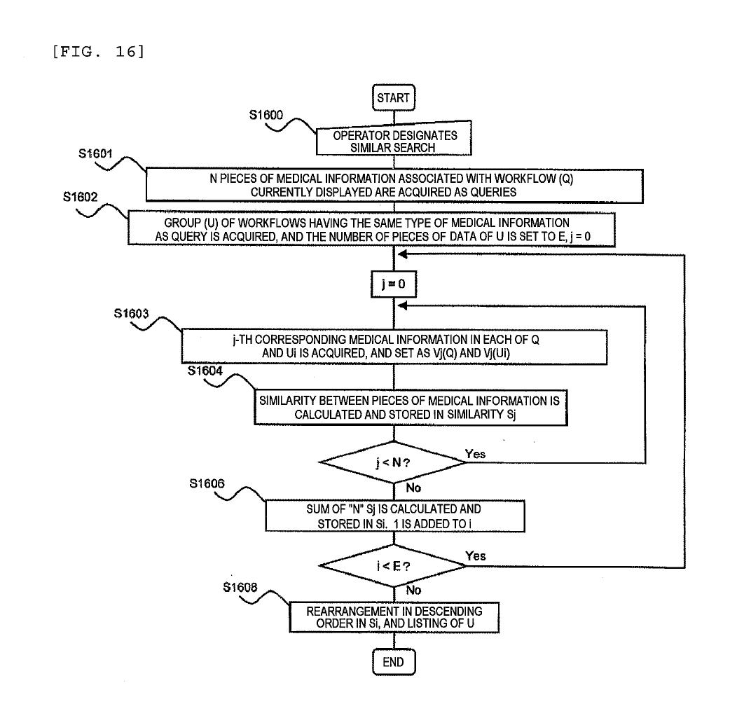

FIG. 16 is a process flow for calculating the similarity between workflows. When a similar case search button is selected (step S1600), the similarity calculation section 181 acquires N pieces of medical information associated with the workflow (Q) that is currently displayed in the workflow step selection area (step S1601). These N pieces of medical information are search case queries.

Then, the similarity calculation section 181 acquires a group (U) of workflows, which have the same type of medical information as these queries, from the medical information database 105 (step S1602). The type of medical information will be described. The type can be specified using the execution-scheduled department 213 of a workflow step, which is associated with the medical information, other than the performer ID 215 or the evidence type 312 described above. For example, the execution-scheduled department 213 associated with each of the N pieces of medical information acquired in S1601 is extracted, medical information with the same set as a set of the extracted execution-scheduled departments 213 and workflows associated with the medical information are acquired, and the workflows are set as a group U of workflows. When the execution-scheduled department 213 associated with each of the N pieces of medical information is extracted and this is a set of {department of internal medicine, department of examination, department of radiology}, the similarity calculation section 181 acquires medical information with a set of {department of internal medicine, department of examination, department of radiology} and workflows, which are associated with the medical information, from the medical information database 105. Similarly, determination regarding the same type may also be performed using the evidence type 312. In addition, a group U of workflows using the combination of the execution-scheduled department 213 and the evidence type 312 may also be acquired. For example, the group U of workflows is acquired by forming a set based on the combination of the execution-scheduled department 213 and the evidence type 312 for each of N pieces of medical information and searching for workflows with a set corresponding to the set based on these N sets. As an example, a set of {department of examination-examination value graph, department of radiology-CT image, and department of radiology-image processing} is extracted from N pieces of medical information, and a set of medical information with the same set as this set and workflows associated with the set of medical information are acquired.

Then, in one workflow Ui in the group U of workflows and the workflow Q currently displayed, medical information including evidence data with the evidence type corresponding to the evidence type of evidence data in medical information in the workflow Q is acquired one by one from the medical information database 105, and these pieces of information are set as Vj(Q) and Vj(Ui) (step S1603). In order to calculate the similarity between Vj(Q) and Vj(Ui), the similarity between the pieces of medical information is calculated using the method described above (step S1604). In this case, when there are multiple Vj(Ui) corresponding to Vj(Q), for example, the position of the workflow step associated with Vj(Q) in the workflow Q, that is, a relative workflow step No. from the workflow step No. 1 is acquired using the workflow step No. field 212, and Vj(Ui) corresponding to Vj(Q) is uniquely determined (for example, Vj(Ui) of the workflow step No. closest to the value of the workflow step No. acquired in the workflow Ui is used) and used in calculating the similarity between the pieces of medical information. After calculating the similarity between all pieces of medical information, the similarity between workflows is calculated by calculating the sum (step S1606). In the present embodiment, weighting is not performed when calculating the similarity between workflows. However, it is possible to acquire the execution date and time of a workflow step, which is associated with each piece of medical information, from the workflow step execution date and time field 214 and to perform weighting for a workflow step having the execution date and time closer to the current step, or it is possible to perform weighting using a conference flag as described above.

Finally, the workflow group U is rearranged in descending order according to the calculated similarity Si between workflows, and this is displayed as a list (step S1608). When one of the workflows displayed in the search result list is selected on the search result screen, specific medical information in the selected workflow, that is, medical information displayed in the medical information display area of the workflow step execution screen is displayed. In addition, reference information referred to in the workflow step included in the selected workflow is acquired on the basis of the reference workflow step No. 306 in the medical information database 105, and is displayed on the screen.

By calculating the similarity between workflows as described above, it is possible to perform appropriately similar case search according to the input condition of medical information. In addition, since the similarity is calculated for all workflows, it is possible to perform similar case search in consideration of the entire medical examination process performed for a patient.

In this example, all medical information of the ongoing workflow is acquired and the similarity is calculated. However, medical information for which the similarity is calculated may be selected. For example,

### <Regarding the Structure of a System Using a Data Center>

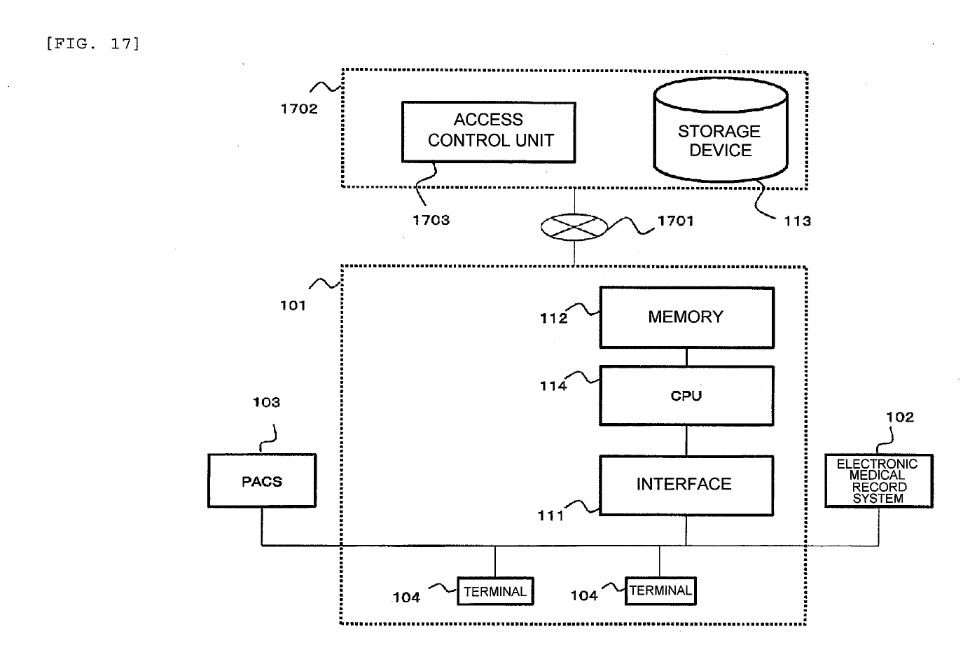

Next, as an example of the system configuration in the present invention, a data center type system will be described in detail. As shown in FIG. 17, the medical examination assistance system 101 is connected to a data center 1702 through a network 1701. The storage device 113 is present in the data center 1702, and access to the storage device 113 is strictly managed by an access control unit 1703. Hospitals can reduce the initial investment at the time of system introduction by utilizing the data center 1702 which is an out-of-hospital facility, and hospitals do not need to perform maintenance and management for the storage device 113.

In addition, as a modification of the above-described example, it is also possible to use a cloud computing type system in which the memory 112 or the CPU 114 is disposed in the data center 1702. In addition, the system configuration using a network in the present invention can be assumed in various forms, but the present embodiment does not limit these.

### REFERENCE SIGNS LIST

101: medical examination assistance system
102: electronic medical record system
103: PACS
104: terminal
105: medical information database
106: medical information storage means
107: workflow step input means
108: input information reception means
109: medical information output means
111: interface
112: memory
113: storage device
114: CPU
115: evidence data processing means
116: examination information database
117: workflow step request input means
118: workflow output means
119: workflow ending means
160: similar case search means
170: process analysis means
181: similarity calculation section
182: similar medical information extraction section
183: reference information extraction section
184: medical information display section
185: reference information storage section
200: workflow information table
201: patient ID field
202: workflow No. field
203: workflow name field
204: workflow start date and time field
205: workflow end date and time field
206: attending doctor ID field
207: conference flag field
210: workflow step information field
211: patient ID field
212: workflow step No. field
213: ID field of a department scheduled to perform a workflow step
214: workflow step execution date and time field
215: workflow step performer ID field
216: workflow step execution flag field
217: conference step flag field
218: workflow No. field
219: parent workflow step No. field
220: child workflow step No. field
300: medical information table
301: patient ID field
305: determination statement field
306: reference workflow step No. field
310: evidence data table
311: evidence No. field
312: evidence type field
313: evidence display icon field
314: evidence display text field
320: processing history table
321: processing No. field
322: processing content field
323: evidence No. field
324: processing parameter field
330: input data table
331: evidence No. field
332: input data ID field
333: input data type field
400: examination value table
401: examination value ID field
402: patient ID field
403: examination result date and time field
404: item code field
405: value field
410: examination item master table
411: item code field
412: item name field
413: unit name field
420: measurement value table
421: measurement value ID field
422: patient ID field
423: measurement result date and time field
424: item code field
425: value field
430: measurement item master table
431: item code field
432: item name field
433: unit name field
434: registration date field
440: image table
441: image ID field
442: patient ID field
443: image acquisition date field
444: item code field
445: image field
700: workflow step execution screen
701: workflow step selection area
702: login information display area
703: determination statement input and output area
704: evidence data display area
705: medical information registration button
706: medical examination assistance button group
710: examination value graph display screen
800: image processing screen
903: workflow step reference history area
904: similar case search button
1301: search result list screen
1302: search result detail screen
1303: apply button
1701: network
1702: data center
1703: access control unit

1. A medical examination assistance system comprising:
a medical information database in which workflow information to identify a workflow that is a flow of a sequence of medical services of a medical intervention, workflow step information including at least either information to identify a workflow step that is a unit of medical intervention included in the workflow or information to identify a workflow step preceding or subsequent to the workflow step, medical information that is information relevant to the medical intervention, and reference information that is information to identify information referred to in the workflow step are stored so as to be associated with each other;
a similarity calculation unit that calculates a similarity between first medical information, which is associated with a workflow step preceding a first workflow step, and medical information stored in the medical information database;
a similar medical information extraction unit that extracts second medical information, which is similar to the first medical information, from the medical information database on the basis of the calculated similarity;
a reference information extraction unit that extracts reference information associated with workflow step information of a second workflow step, which is a workflow step subsequent to a workflow step associated with the extracted second medical information, from the medical information database; and
a medical information display unit that displays the extracted second medical information and the extracted reference information on a screen.

2. The medical examination assistance system according to claim 1, further comprising:
a reference information storage unit that stores the displayed second medical information and the displayed reference information in the medical information database, as first reference information, so as to be associated with the first workflow step information.

3. The medical examination assistance system according to claim 1,
wherein the medical information includes evidence data that is objective biological information acquired from a patient, and
the similarity calculation unit calculates feature amounts for first evidence data included in the first medical information and evidence data included in the medical information stored in the medical information database, calculates a percentile that is a ranking of a numerical value of each of the calculated feature amounts in the medical information database, and calculates the similarity on the basis of the calculated percentile.

4. The medical examination assistance system according to claim 1,
wherein the workflow step information includes conference flag information indicating that a conference was held with respect to the workflow step information, and
the similarity calculation unit extracts a workflow step, which is associated with the medical information stored in the medical information database, and weights the similarity on the basis of the conference flag information included in the extracted workflow step.

5. The medical examination assistance system according to claim 3,
wherein the evidence data includes evidence type information to identify a type of the biological information, and
the similarity calculation unit extracts first evidence type information, which is included in evidence data included in the first medical information, from the medical information database, and calculates a similarity between the first medical information and medical information including evidence data that includes evidence type information corresponding to the extracted first evidence type information.

6. The medical examination assistance system according to claim 1,
wherein the workflow step information includes performer type information to identify a type of a performer of the workflow step, and
the similarity calculation unit extracts first performer type information, which is included in the first workflow step information, from the medical information database, and calculates a similarity between the first medical information and medical information of a workflow step having a performer type corresponding to the first performer type information.

7. The medical examination assistance system according to claim 1,
wherein the medical information includes text data, and
the similarity calculation unit calculates a degree of co-occurrence between first text data included in the first medical information and second text data included in the second medical information and calculates a similarity on the basis of the calculated degree of co-occurrence.

8. A medical examination assistance method of assisting a medical examination using a medical information database in which workflow information to identify a workflow that is a flow of a sequence of medical services of a medical intervention, a workflow step information including at least either information to identify a workflow step that is a unit of medical intervention included in the workflow or information to identify a workflow step preceding or subsequent to the workflow step, medical information that is information relevant to the medical intervention, and reference information that is information to identify information referred to in the workflow step are stored so as to be associated with each other, the medical examination assistance method comprising:
a step of making a similarity calculation unit calculate a similarity between first medical information, which is associated with a workflow step preceding a first workflow step, and medical information stored in the medical information database;
a step of making a similar medical information extraction unit extract second medical information, which is similar to the first medical information, from the medical information database on the basis of the calculated similarity;
a step of making a reference information extraction unit extract reference information associated with workflow step information of a second workflow step, which is a workflow step subsequent to a workflow step associated with the extracted second medical information, from the medical information database; and
a step of making a medical information display unit display the extracted second medical information and the extracted reference information on a screen.

9. The medical examination assistance method according to claim 8, further comprising:
a step of making a reference information storage unit store the displayed second medical information and the displayed reference information in the medical information database, as first reference information, so as to be associated with the first workflow step information.
